(19) United States
(12) Patent Application Publication
(10) Pub. No.: US 2026/0164268 A1
(43) Pub. Date: Jun. 11, 2026

(54) SPEED-BASED TRANSMISSION SCHEME SWITCHING METHOD, COMMUNICATION SYSTEM, AND TEST AND/OR MEASUREMENT SYSTEM

(71) Applicant: Rohde & Schwarz GmbH & Co. KG, Muenchen (DE)

(72) Inventors: Lilei WANG, Beijing (CN); Juergen SCHLIENZ, Muenchen (DE)

(21) Appl. No.: 19/365,942

(22) Filed: Oct. 22, 2025

(30) Foreign Application Priority Data
Dec. 9, 2024 (CN) 2024118031402

(51) Int. Cl. H04W 24/06; H04L 1/00; H04L 5/00

(52) U.S. Cl. CPC H04W 24/06; H04L 1/0003; H04L 1/0009; H04L 5/0085

(57) ABSTRACT

A speed-based transmission scheme switching method of switching a transmission scheme between a transmitter node and a receiver node is described. The method includes: determining at least one speed parameter, wherein the at least one speed parameter includes a speed of the transmitter node, a speed of the receiver node, and/or a relative speed between the transmitter node and the receiver node; and switching, based on the at least one speed parameter determined, between a first transmission scheme being associated with a lower range of the at least one speed parameter and a second transmission scheme being associated with a higher range of the at least one speed parameter. Further, a communication system as well as a test and/or measurement system are described.

### CROSS-REFERENCE(S) TO RELATED APPLICATION(S)

This application claims priority to Chinese Application No. 2024118031402, filed on Dec. 9, 2024, the entire contents of which are disclosed herein in entirety.

### FIELD OF THE DISCLOSURE

Embodiments of the present disclosure generally relate to a speed-based transmission scheme switching method. Embodiments of the present disclosure further relate to a communication system, as well as to a test and/or measurement system.

### BACKGROUND

Wireless communication is based on a modulation that is applied to a radio frequency (RF) signal according to a predetermined modulation scheme, wherein the predetermined modulation scheme is used by both a transmitter node and a receiver node.

In general, the modulation applied needs to ensure that data comprised in the modulated RF signal is correctly transmitted from a transmitter node to the receiver node while being as insensitive to distortions as possible in order to ensure a low symbol error rate. For example, such distortions can be caused by the Doppler effect due to a relative movement of the transmitter node and the receiver node.

Thus, there is a need for a method, a communication system, as well as a test and/or measurement system that provide enhanced robustness against distortions induced by the Doppler effect.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a speed-based transmission scheme switching method of switching a transmission scheme between a transmitter node and a receiver node. In an embodiment, the speed-based transmission scheme switching method comprises:
determining at least one speed parameter, wherein the at least one speed parameter comprises a speed of the transmitter node, a speed of the receiver node, and/or a relative speed between the transmitter node and the receiver node; and
switching, based on the at least one speed parameter determined, between a first transmission scheme being associated with a lower range of the at least one speed parameter and a second transmission scheme being associated with a higher range of the at least one speed parameter.

Therein and hereinafter, the term “node” is understood to denote an electronic circuit, an electronic device or several interoperating electronic devices that is/are configured to communicate with other nodes via wireless RF signals. More precisely, each node may be configured to generate, transmit, and/or receive modulated RF signals that comprise a symbol sequence that is modulated onto the RF signals by a certain modulation technique.

The term “transmission scheme” is understood to denote a series of signal modifications that are applied to an RF signal in order to modulate the symbol sequence onto the RF signal and/or in order to recover the symbol sequence from the modulated RF signal. Accordingly, the transmission scheme comprises a modulation scheme that is applied to the RF signal. Moreover, the transmission scheme may comprise a data coding scheme.

The speed-based transmission scheme switching method according to embodiments of the present disclosure is based on the idea to dynamically switch between different transmission schemes based on the speed of the transmitter node, the speed of the receiver node, and/or the relative speed between the transmitter node and the receiver node.

Different transmission schemes typically provide different performance with different relative speeds between the transmitter node and the receiver node, i.e. one transmission scheme may perform better at lower relative speeds while another transmission scheme may perform better at higher relative speeds.

According to one or more embodiments of the present disclosure, the better-performing transmission scheme is dynamically chosen for communication between the transmitter node and the receiver node based on the at least one speed parameter determined.

Thus, optimal communication performance is ensured for all ranges of the relative speed between the transmitter node and the receiver node with the speed-based transmission scheme switching method according to embodiments of the present disclosure.

According to an aspect of the present disclosure, a switch, for example, from the first transmission scheme to the second transmission scheme is performed if the at least one speed parameter determined is greater than a first speed threshold. In an embodiment, the switch from the first transmission scheme to the second transmission scheme may be performed if the at least one speed parameter determined increases from a region below the first speed threshold to a region above the first speed threshold.

In an embodiment, the first speed threshold may be located in a speed region where the second transmission scheme outperforms the first transmission scheme.

In an embodiment, the first speed threshold may be chosen based on a comparison of the performance of the transmitter node and/or of the receiver node at different speeds using the first transmission scheme and the second transmission scheme.

In an embodiment of the present disclosure, a switch from the second transmission scheme to the first transmission scheme is performed if the at least one speed parameter determined is smaller than a second speed threshold. More precisely, the switch from the second transmission scheme to the first transmission scheme may be performed if the at least one speed parameter determined decreases from a region above the second speed threshold to a region below the second speed threshold.

In an embodiment, the second speed threshold may be located in a speed region where the first transmission scheme outperforms the second transmission scheme.

In an embodiment, the second speed threshold may be chosen based on a comparison of the performance of the transmitter node and/or of the receiver node at different speeds using the first transmission scheme and the second transmission scheme.

An aspect of the present disclosure provides, for example, that the first speed threshold is greater than the second speed threshold. This way, it is ensured that the switch form the first transmission scheme to the second transmission scheme or vice versa is only performed if there is a tangible performance increase after switching the transmission scheme.

For example, the speed thresholds being different from each other ensures that the transmission scheme is not switched repeatedly if the at least one speed parameter has a value around the first speed threshold or the second speed threshold and varies slightly. However, it is noted that the first speed threshold and the second speed threshold could, in principle, also be chosen to be equal.

In another embodiment of the present disclosure, the first transmission scheme is an orthogonal frequency division multiplexing (OFDM) scheme. OFDM schemes provide particularly high performance at lower relative speeds between the transmitter node and the receiver node, for example in the range below the second speed threshold.

For example, the first transmission scheme may be a Cyclic Prefix-Orthogonal Frequency Division Multiplexing (CP-OFDM) scheme or a Discrete Fourier Transform-Spread Orthogonal Frequency Division Multiplexing (DFT-S-OFDM) scheme.

According to another aspect of the present disclosure, the second transmission scheme, for example, is an orthogonal time-frequency-space (OTFS) scheme or a orthogonal time-frequency multiplexing (OTFM) scheme. OTFS schemes and OTFM schemes provide particularly high performance at higher relative speeds between the transmitter node and the receiver node, for example in the range above the first speed threshold.

An aspect of the present disclosure provides, for example, that a full modulation coding scheme (MCS) table is utilized in the first transmission scheme. In general, the MCS table reflects parameters of the wireless connection between the transmitter node and the receiver node.

In an embodiment, the MCS table comprises a plurality of different combinations of modulation schemes and coding schemes, as well as the associated parameters. For example, the MCS table comprises a modulation order, a target code rate, and/or a spectral efficiency.

Based on the MCS table, the transmitter node and the receiver node can select a combination of a modulation scheme and a coding scheme.

In the first transmission scheme, there may be no restrictions, such that the full MCS table may be utilized by the transmitter node and the receiver node.

In an embodiment, an adapted modulation coding scheme (MCS) table is utilized in the second transmission scheme. In other words, a different MCS table may be provided for the second transmission scheme. This way, it is ensured that only the appropriate combinations of modulation schemes and coding schemes can be selected by the transmitter node and the receiver node while employing the second transmission scheme.

In an embodiment, the adapted MCS table may be a reduced version of a full MCS table or a separate MCS table having different properties compared to the full MCS table. It has turned out that the performance of the transmitter node and/or the receiver node can be enhanced while using the second transmission scheme if a reduced MCS table or a separate MCS table having a reduced number of combinations of modulation schemes and coding schemes is utilized in the second transmission scheme.

For example, the adapted MCS table may have a reduced modulation order, reduced coding rate, and/or finer granularity with respect to e.g, the coding rate, the error correction rate, the transport block size, etc. It has turned out that the performance of the transmitter node and/or of the receiver node can be enhanced significantly if such an adapted MCS table is utilized.

In another embodiment of the present disclosure, only continuous resource allocation in frequency domain is utilized in the second transmission scheme. In other words, subsequent subcarriers in frequency domain are all utilized for the second transmission scheme. It has turned out that the performance of the transmitter node and/or of the receiver node in the second transmission scheme can be enhanced significantly when continuous resource allocation in frequency domain is applied.

Accordingly, no blank subcarriers may be inserted between the subcarriers allocated to the second transmission scheme. Likewise, there may be no subcarriers allocated to a different transmission scheme between two subcarriers allocated to the second transmission scheme, for example no subcarriers allocated to the first transmission scheme.

According to an aspect of the present disclosure, both the transmitter node and the receiver node, for example, automatically switch between the first transmission scheme and the second transmission scheme based on the at least one speed parameter determined.

In an embodiment, the at least one speed parameter may be determined by the receiver node and/or by the transmitter node. If the at least one speed parameter is determined only by the receiver node, the at least one speed parameter may be transmitted to the transmitter node by the receiver node. If the at least one speed parameter is determined only by the transmitter node, the at least one speed parameter may be transmitted to the receiver node by the transmitter node.

In another embodiment of the present disclosure, the transmitter node initiates the switching between the first transmission scheme and the second transmission scheme. Accordingly, the transmitter node decides whether the transmission scheme is to be switched.

In an embodiment, the transmitter node may transmit a scheme switching instruction message to the receiver node, and the receiver node may switch between the first transmission scheme and the second transmission scheme based on the scheme switching instruction message.

In an embodiment, the transmitter node may determine the at least one speed parameter. However, it is also conceivable that the receiver node may determine the at least one speed parameter and may transmit the at least one speed parameter determined to the transmitter node.

In another embodiment of the present disclosure, the receiver node initiates the switching between the first transmission scheme and the second transmission scheme. Accordingly, the receiver node decides whether the transmission scheme is to be switched.

In an embodiment, the receiver node may transmit a scheme switching instruction message to the transmitter node, and the transmitter node may switch between the first transmission scheme and the second transmission scheme based on the scheme switching instruction message.

In an embodiment, the receiver node may determine the at least one speed parameter. However, it is also conceivable that the transmitter node may determine the at least one speed parameter and may transmit the at least one speed parameter determined to the receiver node.

According to one or more embodiments of the present disclosure, the problem further is solved by a communication system. In an embodiment, the communication system comprises a transmitter node and a receiver node, wherein the communication system is configured to perform the speed-based transmission scheme switching method according to any one of the embodiments described above.

Regarding the advantages and further properties of the communication system, reference is made to the explanations given above with respect to the speed-based transmission scheme switching method, which also hold for the communication system and vice versa.

Embodiments of the present disclosure also provide a test and/or measurement system. In an embodiment, the test and/or measurement system comprises an emulation circuit and an analysis circuit. The emulation circuit is configured to emulate a transmitter node or a receiver node in order to perform tests and/or measurements on a device under test. The emulation circuit is configured to perform the speed-based transmission scheme switching method according to any one of the embodiments described above in conjunction with the device under test. The analysis circuit is configured to determine at least one performance parameter of the device under test, wherein the at least one performance parameter is associated with the device under test switching between the first transmission scheme and the second transmission scheme.

In an embodiment, the at least one performance parameter may, for example, comprise a bit error rate, a symbol error rate, a signal-to-noise ratio, a switching time taken by the device under test to switch the transmission scheme, and/or a parameter indicating whether the switch between the transmission schemes has been performed correctly by the device under test.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a communication system according to an embodiment of the present disclosure;

FIG. 2 schematically shows a portion of the communication system of FIG. 1 in more detail;

FIG. 3 shows a representative flow chart of a speed-based transmission scheme switching method according to an embodiment of the present disclosure;

FIG. 4 shows an example of a diagram of speed parameter plotted against time illustrating steps of the method of FIG. 3;

FIG. 5 shows an example of a plot of a bit error rate of several different transmission schemes at different Doppler-induced frequency shifts against a signal-to-noise ratio;

FIG. 6 shows an example of a plot of a bit error rate of several different transmission schemes at different modulation orders against a signal-to-noise ratio;

FIG. 7 shows an example of a modulation coding scheme table;

FIG. 8 shows an example of a plot of a bit error rate of a transmission scheme with different resource allocation schemes against a signal-to-noise ratio; and

FIG. 9 schematically shows a test and/or measurement system according to an embodiment of the present disclosure.

### DETAILED DESCRIPTION

The detailed description set forth below in connection with the appended drawings is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

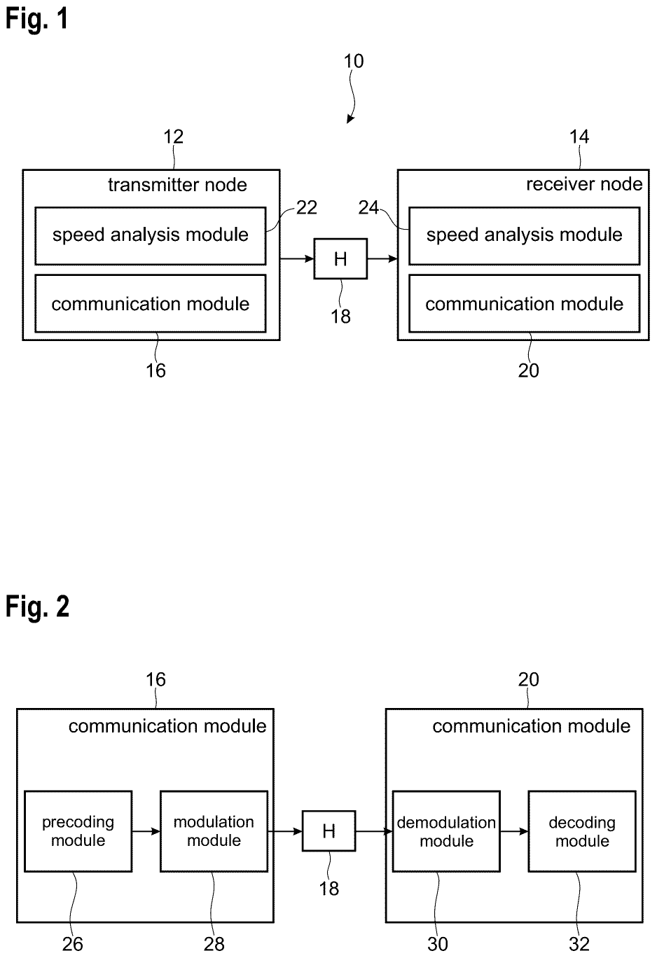

FIG. 1 schematically shows a communication system 10 that comprises a transmitter node 12 and a receiver node 14. In general, the transmitter node 12 and the receiver node 14 are configured to communicate with each other via wireless RF signals based on a certain wireless communication standard such as WLAN, 4G or 5G. For example, the transmitter node 12 comprises a communication circuit 16 that may be configured to generate and transmit a modulated RF signal that comprises a symbol sequence that is modulated onto the RF signal by a certain modulation technique.

The modulated RF signal is transmitted over a transmission path 18 that has a certain transfer function H. The receiver node 14 comprises a communication circuit 20 that is configured to receive and demodulate the modulated RF signal received via the transmission path 18.

It is noted that the transmitter node 12 and/or the receiver node 14 may be established as a transceiver, i.e. the transmitter node 12 and/or the receiver node 14 may be configured to both transmit and receive modulated RF signals. For example, the transmitter node 12 may be a user equipment (UE) device, such as a smartphone, a tablet, a handheld radio, or any other type of UE device being configured for wireless communication. As a further example, the receiver node 14 may be a base station. However, it is also conceivable that the receiver node 14 may be a UE device and/or that the transmitter node 12 may be a base station.

In the example embodiment shown in FIG. 1, the transmitter node 12 comprises a speed analysis circuit 22. Moreover, the receiver node 14 also comprises a speed analysis circuit 24. However, it is to be understood that, alternatively, only the speed analysis circuit 22 of the transmitter node 12 or the only the speed analysis circuit of the receiver node 14 may be provided.

In general, the speed analysis circuits 22, 24 are configured to determine at least one speed parameter associated with the transmitter node 12 and/or with the receiver node 14, as will be described in more detail below.

FIG. 2 schematically shows an example embodiment of a portion of the communication system 10, the portion comprising a portion of the communication circuit 16 of the transmitter node 12, the transmission path 18, and a portion of the communication circuit 20 of the receiver node 14. The communication circuit 16 of the transmitter node 12 comprises a precoding circuit 26 and a modulation circuit 28 that is provided downstream of the precoding circuit 26. The communication circuit 20 of the receiver node 14 comprises a demodulation circuit 30 and a decoding circuit 32 that is provided downstream of the demodulation circuit 30.

It is noted that the communication circuits 16, 20 may comprise further components that are not shown in FIG. 2. In an embodiment, further components may be provided upstream of the precoding circuit 26. Likewise, further components may be provide downstream of the decoding circuit 32.

In general, the communication circuit 16 of the transmitter node 12 and the communication circuit 20 of the receiver node 14 are configured to selectively employ one of at least two different transmission schemes. For example, the at least two different transmission schemes comprise a first transmission scheme that has higher performance at lower relative speeds between the transmitter node 12 and the receiver node 14, as well as a second transmission scheme that has higher performance at higher relative speeds between the transmitter node 12 and the receiver node 14.

For example, the first transmission scheme may be an orthogonal frequency division multiplexing (OFDM) scheme, for example a Cyclic Prefix-Orthogonal Frequency Division Multiplexing (CP-OFDM) scheme or a Discrete Fourier Transform-Spread Orthogonal Frequency Division Multiplexing (DFT-S-OFDM) scheme. The second transmission scheme may be an orthogonal time-frequency-space (OTFS) scheme or a orthogonal time-frequency multiplexing (OTFM) scheme.

In an embodiment, the ability to use the second transmission scheme may be provided on top of the ability to use the first transmission scheme.

In the example case of FIG. 2, the OFDM scheme may be performed by the modulation circuit 28 and the demodulation circuit 30, i.e, the precoding circuit 26 and the decoding circuit 32 may be inactive. In other words, in the first transmission mode, only the modulation circuit 28 and the demodulation circuit 30 may be active, wherein the OFDM modulation is performed according to an arbitrary variant known in the state of the art.

In the second transmission scheme, which is e.g. an OTFS scheme, the precoding circuit 26 and the decoding circuit 32 may be activated. In an embodiment, the precoding circuit 26 may perform an Inverse Symplectic Fast Fourier Transform (ISFFT) from the delay-Doppler-domain into the time-frequency domain.

The ISFFT is defined by

$$X [ n , m ] = \frac{1}{\sqrt{NM}} {\sum }_{k = 0}^{N - 1} {\sum }_{l = 0}^{M - 1} x [ k , l ] \text{?}$$

$$\text{?} \text{indicates text missing or illegible when filed}$$

In an embodiment, the decoding circuit 32 may perform a Symplectic Fast Fourier Transform (SFFT) from the time-frequency domain to the delay-Doppler-domain.

The SFFT is defined by

$$y [ k , l ] = \frac{1}{\sqrt{NM}} {\sum }_{n = 0}^{N - 1} {\sum }_{m = 0}^{M - 1} Y [ n , m ] \text{?}$$

$$\text{?} \text{indicates text missing or illegible when filed}$$

Therein, x[k,1] is the signal in delay-Doppler domain, while X [n,m] is the signal in the time-frequency domain

Using the implementation shown in FIG. 2, the first transmission scheme and the second transmission scheme are allowed to coexist. The whole slot/frame may be based on the first transmission scheme, and the resources of the second transmission scheme may be part of the whole slot/frame.

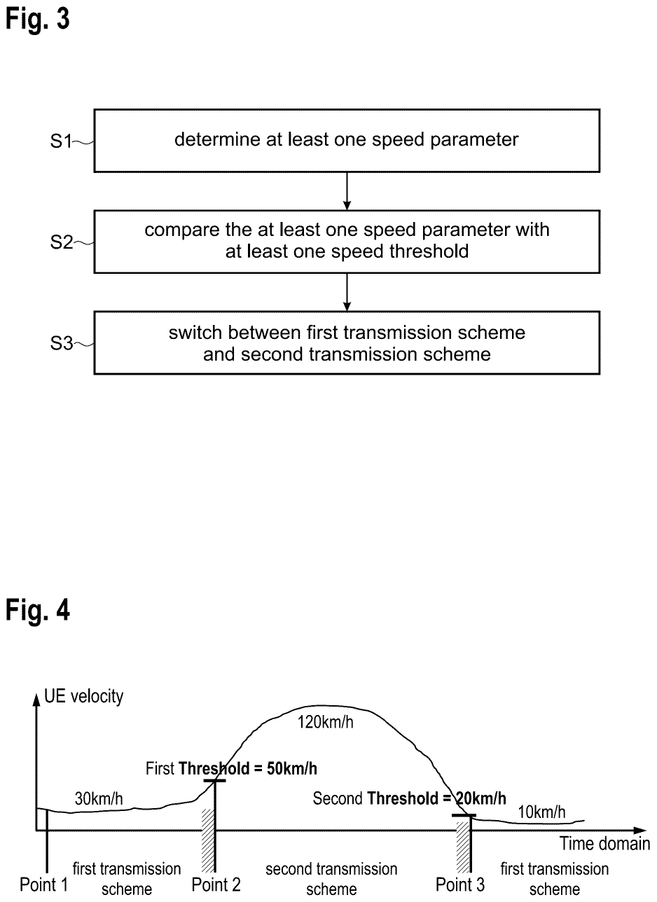

The communication system 10 is configured to perform a speed-based transmission scheme switching method, an example of which is described hereinafter with reference to FIG. 3.

At least one speed parameter is determined by the speed analysis circuit 22 of the transmitter node 12 and/or by the speed analysis circuit 24 of the receiver node 14 (step S1).

In general, the at least one speed parameter is indicative of a relative speed between the transmitter node 12 and the receiver node 14. In an embodiment, the at least one speed parameter determined may comprise a speed of the transmitter node 12, a speed of the receiver node 14, and/or a relative speed between the transmitter node 12 and the receiver node 14.

For example, the speed analysis circuits 22, 24 may comprise a GNSS circuit that is configured to derive the at least one speed parameter from a GNSS location of the transmitter node 12 and/or of the receiver node 14 obtained by the respective GNSS circuit. As another example, the speed analysis circuits 22, 24 may be configured to determine the at least one speed parameter based on a Doppler shift of RF signals exchanged between the transmitter node 12 and the receiver node 14, for example based on a Doppler shift of a pilot signal having a known frequency. In another example, the speed analysis circuits 22, 24 may be configured to identify the at least one speed parameter from an application layer and/or an implementation algorithm.

The at least one speed parameter determined is compared with at least one speed threshold by the respective speed analysis circuit 22, 24 (step S2).

In a specific example embodiment, the at least one speed parameter determined is compared with a first speed threshold and with a second speed threshold, wherein the first speed threshold is greater than the second speed threshold.

If at least one comparison criterion is met in step S2, a switch between the first transmission scheme being associated with a lower range of the at least one speed parameter and the second transmission scheme being associated with a higher range of the at least one speed parameter is performed (step S3).

In an embodiment, if the at least one speed parameter determined crosses the first speed threshold from below, a switch from the first transmission scheme to the second transmission scheme is performed. If the at least one speed parameter determined crosses the second speed threshold from above, a switch from the second transmission scheme to the first transmission scheme is performed.

An example case is illustrated in FIG. 4, which shows a diagram of a UE velocity plotted against time. In this case, for example, the transmitter node 12 may be the UE device, while the receiver node 14 may be a stationary base station. Accordingly, the at least one speed parameter may be the velocity of the transmitter node 12.

In a first time interval between “Point 1” and “Point 2”, the at least one speed parameter is about 30 km/h, and is above the second speed threshold, which is exemplarily set to 20 km/h. However, as the at least one speed parameter is smaller than the first speed threshold, which is set, for example, to 50 km/h, the transmission scheme used by the transmitter node 12 and the receiver node 14 is not switched.

At “Point 2”, the at least one speed parameter crosses the first speed threshold from below, and the transmission scheme used by the transmitter node 12 and the receiver node 14 is switched to the second transmission scheme. At “Point 3”, the at least one speed parameter crosses the second speed threshold from above, and the transmission scheme used by the transmitter node 12 and the receiver node 14 is switched to the first transmission scheme.

It is noted that the transmission scheme is not switched back to the first transmission scheme when the at least one speed parameter crosses the first speed threshold from above.

The switching from the first transmission scheme to the second transmission scheme may be initiated according to one of three scenarios.

According to a first scenario, the transmitter node 12 and the receiver node 14 may both be configured to automatically switch between the first transmission scheme and the second transmission scheme based on the at least one speed parameter determined.

In an embodiment, the at least one speed parameter may be determined by the receiver node 14 and/or by the transmitter node 12. If the at least one speed parameter is determined only by the receiver node 14, the at least one speed parameter may be transmitted to the transmitter node 12 by the receiver node 14. If the at least one speed parameter is determined only by the transmitter node 12, the at least one speed parameter may be transmitted to the receiver node 14 by the transmitter node 12.

According to a second scenario, the transmitter node 12 is configured to initiate the switching between the first transmission scheme and the second transmission scheme. Accordingly, the transmitter node 12 decides whether the transmission scheme is to be switched.

In an embodiment, the transmitter node 12 may transmit a scheme switching instruction message to the receiver node 14, and the receiver node 14 may switch between the first transmission scheme and the second transmission scheme based on the scheme switching instruction message.

According to a third scenario, the receiver node 14 is configured to initiate the switching between the first transmission scheme and the second transmission scheme. Accordingly, the receiver node 14 decides whether the transmission scheme is to be switched.

In an embodiment, the receiver node 14 may transmit a scheme switching instruction message to the transmitter node 12, and the transmitter node 12 may switch between the first transmission scheme and the second transmission scheme based on the scheme switching instruction message.

It is noted that, after switching from the first transmission scheme to the second transmission scheme or vice versa, if the receiver node 14 or the transmitter node 12 detects a worse communication performance, the receiver node 14 or the transmitter node 12 may initiate a switch back to the previous transmission scheme.

In an embodiment, the first speed threshold may be chosen based on a comparison of the performance of the transmitter node 12 and/or of the receiver node 14 at different speeds using the first transmission scheme and the second transmission scheme. For example, the first speed threshold may be chosen such that the second transmission scheme provides better performance than the first transmission scheme if the at least one speed parameter is above the first speed threshold.

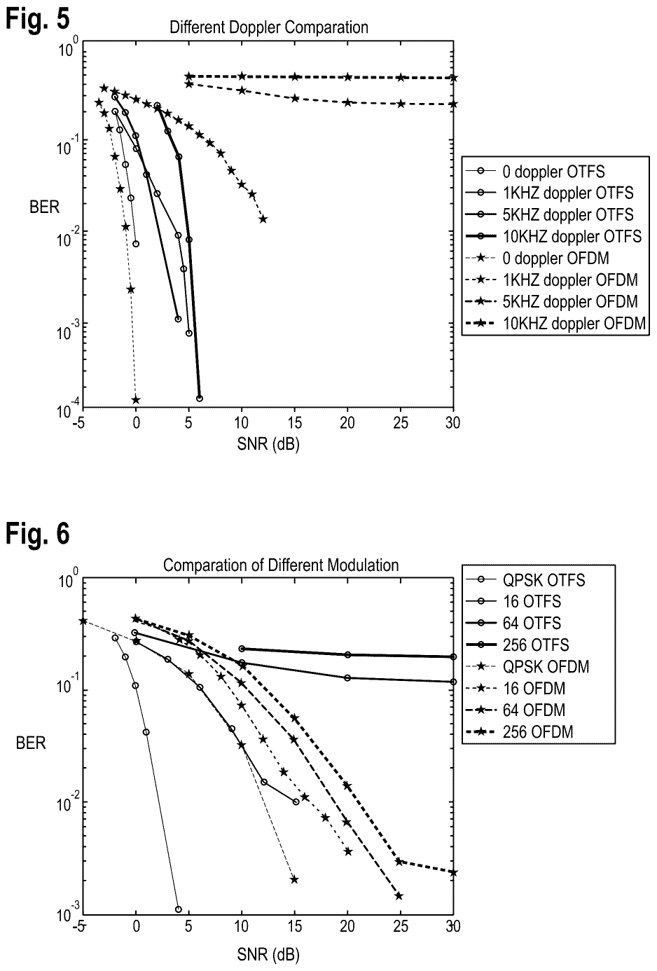

This example is illustrated in FIG. 5, which shows a comparison of the bit error rate (BER) obtained with an OFDM scheme and an OTFS scheme at different Doppler shifts (i.e. at different relative velocities) over a signal-to-noise-ratio (SNR).

Likewise, the second speed threshold may be chosen such that the first transmission scheme provides better performance than the second transmission scheme if the at least one speed parameter is below the second speed threshold.

In an embodiment, the first speed threshold and/or the second speed threshold may be determined according to a radio resource control (RRC) protocol.

As is illustrated in FIGS. 5 and 6, the performance of the second transmission scheme may be better than the performance of the first transmission scheme only if the second transmission scheme is restricted with respect to modulation order and/or coding rate.

In an embodiment, in the second transmission scheme, the modulation order may be restricted to be smaller than or equal to a predefined modulation order threshold. Alternatively or additionally, in the second transmission scheme, the coding rate may be restricted to be smaller than or equal to a predefined coding rate threshold.

As a result, while a full modulation coding scheme (MCS) table may be utilized in the first transmission scheme, an adapted MCS table or a reduced MCS table may be utilized in the second transmission scheme.

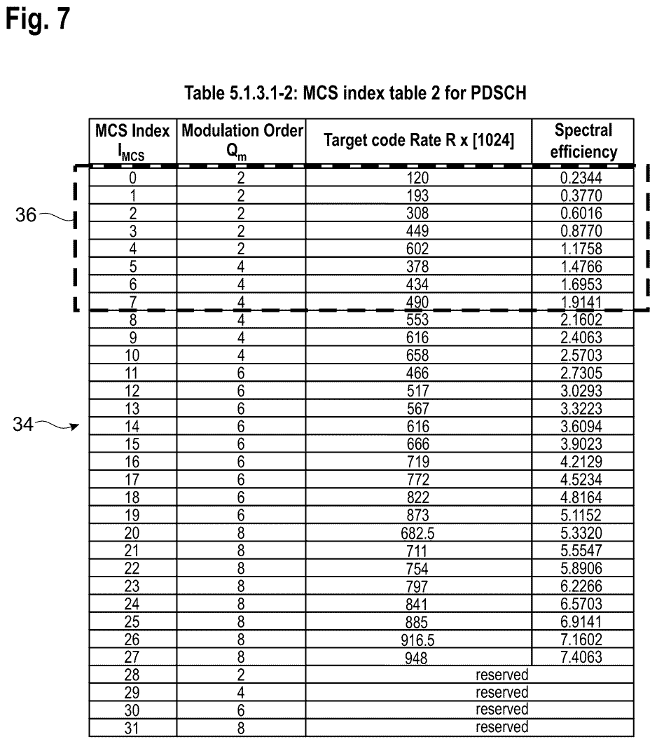

An example case is illustrated in FIG. 7, which shows a representative MCS table 34 comprising a plurality of combinations of modulation schemes (or modulation orders) and coding rates that can be employed by the transmitter node 12 and the receiver node 14 in the first transmission scheme.

In the second transmission scheme, only a subset 36 of the MCS table 34 may be allowed, wherein the subset 36 is restricted to the predefined modulation order threshold and to the predefined coding rate threshold. Further, in the second transmission scheme, only continuous resource allocation in frequency domain may be utilized. Accordingly, no blanks may be inserted between the subcarriers allocated to the second transmission scheme. Likewise, there may be no subcarriers allocated to a different transmission scheme between two subcarriers allocated to the second transmission scheme, for example no subcarriers allocated to the first transmission scheme.

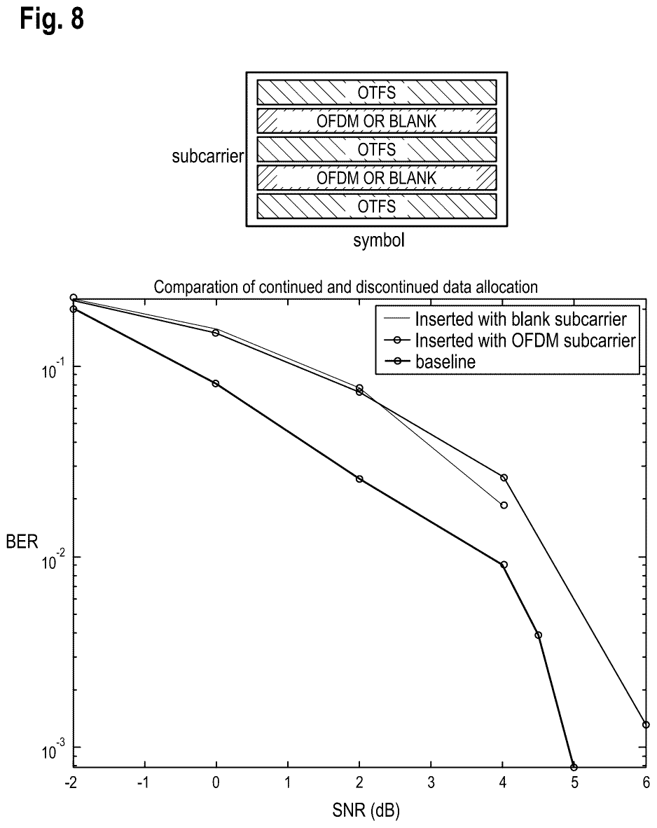

A comparison of the performance for continuous resource allocation with non-continuous allocation cases is illustrated in FIG. 8. As shown in FIG. 8, the “baseline” curve corresponds to the continuous resource allocation, and the other two curves correspond to blank subcarriers or OFDM subcarriers being provided in between the OTFS subcarriers.

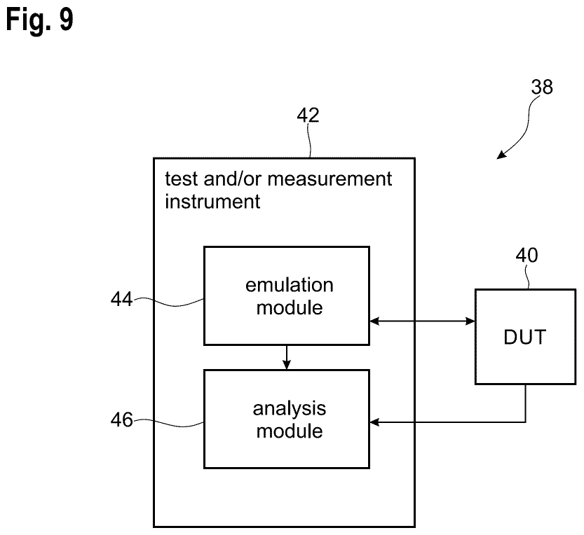

FIG. 9 schematically shows a test and/or measurement system 38 being configured to perform tests and/or measurements on a device under test (DUT) 40. In an embodiment, the device under test 40 may, for example, be the transmitter node 12 or the receiver node 14 according to any one of the embodiments described above.

In an embodiment, the test and/or measurement system 38 comprises a test and/or measurement instrument 42 with an emulation circuit 44 and an analysis circuit 46. It is noted that while both the emulation circuit 44 and the analysis circuit 46 are shown to be integrated into the test and/or measurement instrument 42 in FIG. 9, the emulation circuit 44 or the analysis circuit 46 may alternatively be established separately from the test and/or measurement instrument 42.

In an embodiment, the emulation circuit 44 is configured to emulate the transmitter node 12 and/or the receiver node 14 described above for performing tests on the device under test 40. In other words, the emulation circuit 44 is configured to perform the speed-based transmission scheme switching method described above in conjunction with the device under test 40. In an embodiment, the emulation circuit 44 may emulate a speed of the emulated receiver node or transmitter node by, for example, providing appropriate GNSS data or by applying an appropriate Doppler shift to signals transmitted to the device under test 40 and/or to signals received from the device under test.

In an embodiment, the analysis circuit 46 is connected to the emulation circuit 44 and to the device under test 40. The analysis circuit is configured to determine at least one performance parameter of the device under test 40 based on signals received from the emulation circuit 44 and/or from the device under test 40. In general, the at least one performance parameter is associated with the device under test 40 switching between the first transmission scheme and the second transmission scheme

For example, the at least one performance parameter may comprise a bit error rate, a symbol error rate, a signal-to-noise ratio, a switching time taken by the device under test 40 to switch between the transmission schemes, and/or a parameter indicating whether the switch between the transmission schemes has been performed correctly by the device under test 40.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be used synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the communication system 10, system 38, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A speed-based transmission scheme switching method of switching a transmission scheme between a transmitter node and a receiver node, the method comprising:
determining at least one speed parameter, wherein the at least one speed parameter comprises a speed of the transmitter node, a speed of the receiver node, and/or a relative speed between the transmitter node and the receiver node; and
switching, based on the at least one speed parameter determined, between a first transmission scheme being associated with a lower range of the at least one speed parameter and a second transmission scheme being associated with a higher range of the at least one speed parameter.

2. The speed-based transmission scheme switching method of claim 1, wherein a switch from the first transmission scheme to the second transmission scheme is performed if the at least one speed parameter determined is greater than a first speed threshold.

3. The speed-based transmission scheme switching method of claim 1, wherein a switch from the second transmission scheme to the first transmission scheme is performed if the at least one speed parameter determined is smaller than a second speed threshold.

4. The speed-based transmission scheme of claim 2, wherein the first speed threshold is greater than the second speed threshold.

5. The speed-based transmission scheme switching method of claim 1, wherein the first transmission scheme is an orthogonal frequency division multiplexing (OFDM) scheme.

6. The speed-based transmission scheme switching method of claim 1, wherein the second transmission scheme is an orthogonal time-frequency-space (OTFS) scheme or a orthogonal time-frequency multiplexing (OTFM) scheme.

7. The speed-based transmission scheme switching method of claim 1, wherein a full modulation coding scheme (MCS) table is utilized in the first transmission scheme.

8. The speed-based transmission scheme switching method of claim 1, wherein an adapted modulation coding scheme (MCS) table is utilized in the second transmission scheme.

9. The speed-based transmission scheme switching method of claim 8, wherein the adapted MCS table is a reduced version of a full MCS table or a separate MCS table having different properties compared to the full MCS table.

10. The speed-based transmission scheme switching method of claim 1, wherein only continuous resource allocation in frequency domain is utilized in the second transmission scheme.

11. The speed-based transmission scheme switching method of claim 1, wherein both the transmitter node and the receiver node automatically switch between the first transmission scheme and the second transmission scheme based on the at least one speed parameter determined.

12. The speed-based transmission scheme switching method of claim 1, wherein the transmitter node initiates the switching between the first transmission scheme and the second transmission scheme.

13. The speed-based transmission scheme switching method of claim 1, wherein the receiver node initiates the switching between the first transmission scheme and the second transmission scheme.

14. A communication system, comprising: a transmitter node and a receiver node, wherein the communication system is configured to perform the speed-based transmission scheme switching method according to claim 1.

15. A test and/or measurement system, comprising: an emulation circuit and an analysis circuit, wherein the emulation circuit is configured to emulate a transmitter node or a receiver node in order to perform tests and/or measurements on a device under test,
wherein the emulation circuit is configured to perform the speed-based transmission scheme switching method according to claim 1 in conjunction with the device under test, and
wherein the analysis circuit is configured to determine at least one performance parameter of the device under test, wherein the at least one performance parameter is associated with the device under test switching between the first transmission scheme and the second transmission scheme.
